(19) United States
(12) Patent Application Publication
(10) Pub. No.: US 2025/0212178 A1
(43) Pub. Date: Jun. 26, 2025

(54) DYNAMIC NETWORK RESOURCE ALLOCATION USING RADIO AREA NETWORK SYNCHRONIZATION REQUIREMENTS

(71) Applicant: Aclara Technologies LLC, St. Louis, MO (US)

(72) Inventors: Jeff Sumrall Anderson, St. Louis, MO (US); Christopher Keith Fleck, St. Louis, MO (US)

(21) Appl. No.: 18/985,374

(22) Filed: Dec. 18, 2024

Related U.S. Application Data
(60) Provisional application No. 63/612,691, filed on Dec. 20, 2023.

(51) Int. Cl. H04W 72/02; H04W 24/02; H04W 72/51

(52) U.S. Cl. CPC H04W 72/02; H04W 24/02; H04W 72/51

(57) ABSTRACT

Devices, systems, and methods for operating a wireless network using dynamic network resource requirements. An example device may include an electronic processor and a transceiver coupled to the electronic processor. The electronic processor is configured to receive, via the transceiver, at least one network message including one or more network resources, wherein the one or more network resources have at least one associated RAN synchronization requirement. The electronic processor is configured to determine at least one RAN synchronization capability for the wireless communication device. The electronic processor is configured to determine at least one available network resource by selecting, from the one or more network resources the at least one available network resource when the at least one RAN synchronization capability meets the at least one associated RAN synchronization requirement. The electronic processor is configured to control the transceiver to transmit using the at least one available network resource.

### CROSS-REFERENCE TO RELATED APPLICATIONS

The present application is related to and claims benefit under 35 U.S.C. § 119(e) from U.S. Provisional Patent Application Ser. No. 63/612,691, filed Dec. 20, 2023, entitled “Dynamic Network Resource Allocation Using Radio Area Network Synchronization Requirements,” the entire contents of which is incorporated herein by reference.

### BACKGROUND OF THE INVENTION

Utilities, for example, electric utilities, use wireless data communication networks to connect smart devices for monitoring and controlling their infrastructure. For example, electric usage meters, sensors, and other devices may provide telemetry data to automated billing and monitoring systems for an electric utility. Increasingly, such communications are two-way, for example, when used for controlling smart electric grids using distributed automation. Such wireless communication networks may include hundreds of base stations communicating with thousands of end nodes using limited radiofrequency spectrum.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates a communications system in accordance with some embodiments.

FIG. 2 is a diagram of a wireless base station of the system of FIG. 1 in accordance with some embodiments.

FIG. 3 is a diagram of an example timing structure used by the system of FIG. 1 in accordance with some embodiments.

FIG. 4 illustrates aspects of the operation of the system of FIG. 1 in accordance with some embodiments.

FIG. 5 illustrates aspects of the operation of the system of FIG. 1 in accordance with some embodiments.

FIG. 6 is a flowchart illustrating a method for operating a network resource client in accordance with some embodiments.

FIG. 7 is a flowchart illustrating a method for operating a network resource server in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments illustrated.

In some instances, the apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Some radio area networks may be short packet wireless communication networks including hundreds of base stations communicating with thousands of end nodes using limited radiofrequency (RF) spectrum. Such networks, for example, Time Division Multiple Access (TDMA) based networks, rely on synchronization of time slots to provide efficient and reliable wireless communications. Other networks, for example, Frequency Division Multiple Access (FDMA) based networks, rely on frequency synchronization. Some networks may require both to meet regulatory compliance. These networks need to support many different types of devices (end nodes) with potentially vastly different frequency and time synchronization capabilities. For example, electric meters by their nature have AC power continuously during normal operations and may be able to maintain tight synchronization because on board timing devices can be run continuously. In another example, gas and water meters run on batteries, and only wake up periodically to transmit and/or receive data. Such devices are not able to maintain as tight of synchronization with the radio area network as devices, which are powered up continuously. Some networks may include power harvesting devices, which may have more dynamic wake up and synchronization capabilities, which may not be easily predictable. Similarly, Internet of Things (IoT) devices (e.g., smart sensors) may have longer sleep cycles, waking up once per day or week, and/or only when event triggered.

Another complicating factor occurs when devices experience time synchronization degradation (e.g., the device loses GPS coverage for brief periods of time). It is preferable that the radio area network continue to operate despite this degradation, even with decreased network performance. In a traditional wireless TDMA network, when a base station cannot maintain its time synchronization, it terminates its transmissions to avoid interfering with other base station's transmissions. However, this results in a total loss of base station capabilities. Traditional wireless TDMA networks have a small, fixed guard time allocation for payload channels, and a “sloppy” synchronization channel with large, fixed guard times (as compared to the fixed guard time allocation for payload channels). Each time a device desires to transmit, it must first go through a signaling procedure on the sloppy synchronization channel to get synchronized to tight radio area network timing for signaling and payload channels.

To address these problems and for other reasons, systems and methods are provided herein for using dynamic radio area network synchronization requirements. Among other things, embodiments described herein provide for a variable guard time duration, which can be optimized for the specific group of devices accessing a set of radio network resources. Network resources include an allocation of a physical carrier (e.g., a frequency), a subset of a physical carrier (e.g., one or more time slots within a physical carrier), or may span over multiple physical carriers. Using embodiments described herein, a network resource server sends network control information (e.g., through broadcast, multicast, or unicast messaging), which includes the current configuration of, for example, the guard time, the required timing error thresholds, and the required frequency error thresholds for the various network resources.

As described herein, network devices track both the current network control information for network resources, and their own time and frequency error estimates. When a device desires to transmit, it checks the current network resource configuration and its current error estimations (e.g., timing or frequency error estimations), comparing them to the network resource error thresholds. In some instances, when the estimated error is below the associated network resource's error threshold, the device can transmit using that network resource. When the error is over the threshold, transmission is not permitted, thus eliminating the potential interference and/or regulatory issues.

Using such embodiments, a radio area network can operate using dynamic frequency and time errors, which are acceptable given a current RAN synchronization configuration. This allows devices to participate in the network based on their performance capabilities. For example, network resources can be tailored based on a device's frequency and timing accuracy. This reduces both packet delay time and RF bandwidth. Aspects and embodiments presented herein provide an improvement over current systems, which are configured with only a single level of timing tolerance across all devices. For example, using embodiments described herein, a base station, in the event of time synchronization degradation, can dynamically reconfigure the network resources to have larger guard times (e.g., at the expense of smaller payload slot times) and increase the timing and/or frequency error thresholds of the network resources. Such embodiments permit radio area network operations to continue, albeit with less performance. The dynamic radio area network synchronization techniques described herein are applicable to frequency and time synchronization.

Such embodiments provide increased network efficiency by using tighter thresholds when conditions allow and improve network uptime by allowing some level of operations to continue during loss or degradation of a server's timing reference. Using such embodiments, availability is increased while overhead is limited, resulting in increased network throughput. This, in turn, leads to a more efficient and effective use of the network and its computing resources.

One example embodiment provides a wireless communication device including: an electronic processor; and a transceiver coupled to the electronic processor; wherein the electronic processor is configured to: receive, via the transceiver, at least one network message including one or more network resources, wherein the one or more network resources have at least one associated RAN synchronization requirement; determine at least one RAN synchronization capability for the wireless communication device; determine at least one available network resource by selecting, from the one or more network resources the at least one available network resource when the at least one RAN synchronization capability meets the at least one associated RAN synchronization requirement; and control the transceiver to transmit using the at least one available network resource.

Another example embodiment provides a method for operating a wireless communication device including: an electronic processor; and a transceiver coupled to the electronic processor; wherein the electronic processor is configured to: determine, for a network resource, a RAN synchronization requirement; transmit, via the transceiver, a first network message to a second wireless communication device, the first network message including the network resource and the RAN synchronization requirement; responsive to determining a changing network condition, generate an updated RAN synchronization requirement for the network resource; and transmit, via the transceiver, a second network message to the second wireless communication device including the network resource and the updated RAN synchronization requirement.

For ease of description, some or all of the example systems presented herein are illustrated with a single exemplar of each of its component parts. Some examples may not describe or illustrate all components of the systems. Other example embodiments may include more or fewer of each of the illustrated components, may combine some components, or may include additional or alternative components.

It should be understood that although certain figures presented herein illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

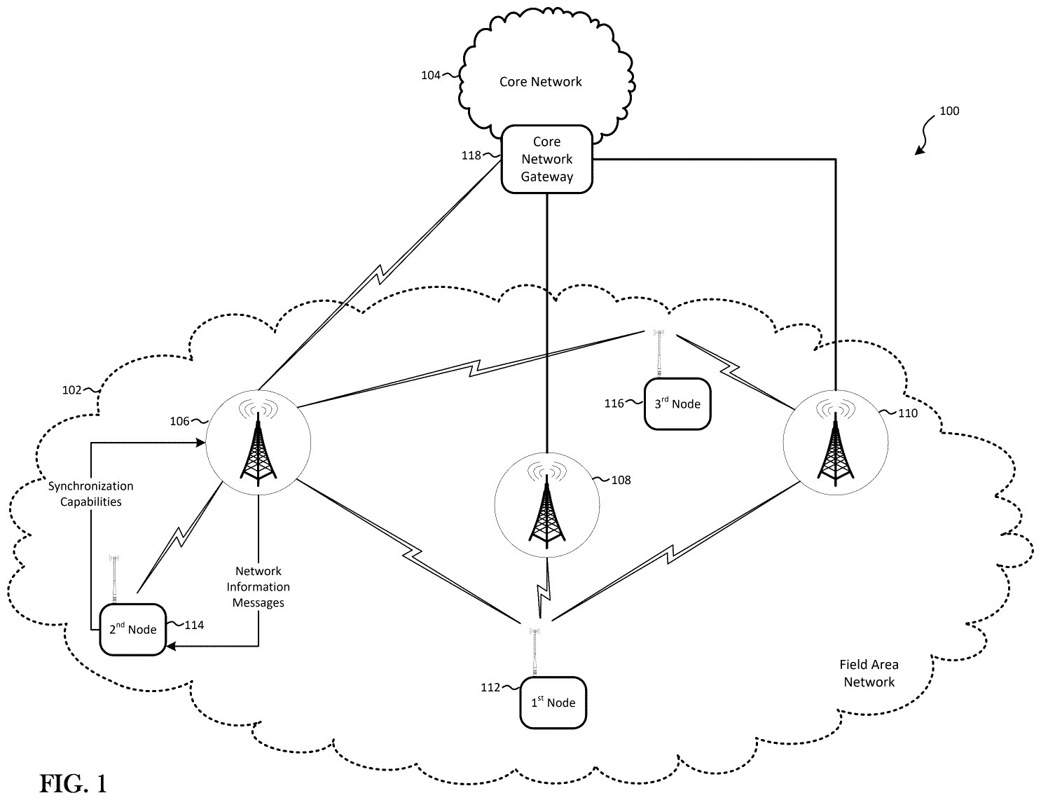

FIG. 1 is a diagram of one example embodiment of a wireless communication system 100. In the example illustrated, the system 100 includes a field area network 102 and a core network 104. In the illustrated example, the field area network 102 is a radio area network (RAN) comprised of wireless communication devices, including a first base station 106, a second base station 108, a third base station 110, a first end node 112, a second end node 114, and a third end node 116. In one example, the field area network 102 is low power short packet wireless communication network deployed to monitor and control equipment on an electric utility grid and the core network 104 is a back end computing network for the electric utility (including, for example, billing systems, grid monitoring systems, and other command and control for the electric grid). The first end node 112, the second end node 114, and the third end node 116 each include appropriate hardware and software components (e.g., electronic processors, memories, transceivers) for operating the end nodes as described herein. It should be noted that end nodes may be logical or physical in nature. For example, as illustrated in FIG. 1, each of the first end node 112, the second end node 114, and the third end node 116 may be implemented as a separate hardware device. However, in some aspects, a single hardware device may implement multiple logical end nodes (e.g., in software).

In the example illustrated, the field area network 102 is communicatively coupled to the core network 104 by a core network gateway 118. For example, each of the first base station 106, the second base station 108, and the third base station 110 are coupled to the core network gateway 118 via a suitable wired or wireless backhaul connection. The core network gateway 118 includes hardware and software components (e.g., electronic processors, memories, transceivers) for controlling electronic communications between the field area network 102 and the core network 104. In some embodiments, the core network 104 may be a cloud computing platform accessible via one or more networks, including over the Internet using encrypted tunnels or another secure virtual network connection.

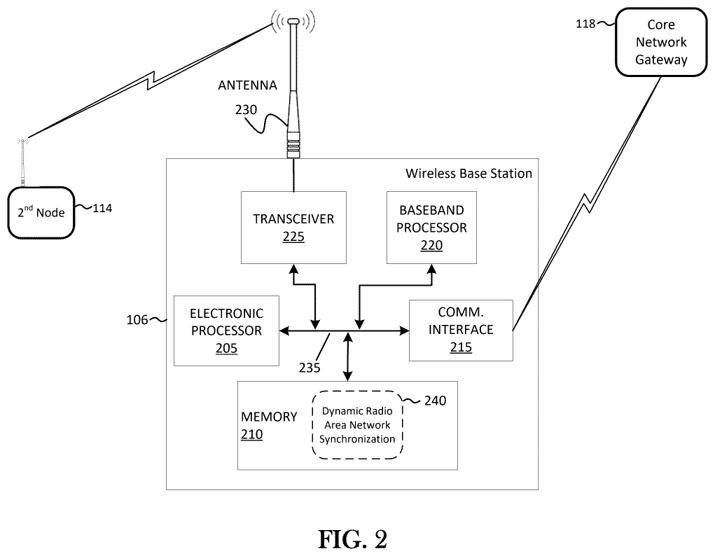

The first base station 106, the second base station 108, and the third base station 110, described more particularly with respect to FIG. 2, are wireless base stations for operating the field area network 102 to provide wireless communications to, from, and between the first end node 112, the second end node 114, and the third end node 116. In some instances, a base station of the field area network 102 may be referred to as a “field network gateway” or an “FNG.”

The system 100 may include more components than those illustrated. In particular, it should be understood that, although FIG. 1 illustrates only three base stations and three end nodes, the system 100 may include a field area network with tens, hundreds, or even thousands of base stations servicing tens, hundreds, or even thousands of end nodes.

In one example, the field area network 102 is a wireless network operating in the 450-470 MHz band using 12.5 kHz channels to provide narrowband packet-based data communications between 5 and 10 kbps. In one example, each of the base stations in the field area network 102 is configured to transmit data to the end nodes on a single downlink channel and receive data from the end nodes on one of many uplink channels, where the uplink and downlink frequencies are the same for each base station. Likewise, each of the end nodes may be configured to receive data using the same downlink channel and transmit data on the same uplink channels. In some instances, the field area network 102 operates in geographic proximity to other users using the same or adjacent frequencies allocated from the same band as the field area network downlink and uplink channels.

As illustrated in FIG. 1, an end node may be able transmit signals that can be received by multiple base stations and, likewise, be able to receive signals transmitted from multiple base stations. For example, the first end node 112 is able to communicate with all three base stations, whereas the second end node 114 is only able to communicate with the first base station 106, and the third end node 116 is able to communicate with the first base station 106 and the third base station 110, but not the second base station 108. In some instances, an end node may be able to receive transmissions from a particular base station but may be unable to send transmissions receivable by that base station. In some instances, an end node may be able to send transmissions receivable by a particular base station but be unable to receive transmissions from that base station.

As an example, FIG. 1 is illustrated with the second end node 114 in communication with the first base station 106. As illustrated in FIG. 1, and described herein, the first base station 106 sends network information messages to the end nodes (including the second end node 114), and the end nodes (including the second end node 114) send uplink data and information relating to their respective RAN synchronization capabilities to the base stations (including the first base station 106).

The base stations and end nodes of the field area network 102 may be collectively referred to herein as “field nodes.” Each field node of the field area network 102 can serve as a managed device, a distributed coordinator, or both depending on the circumstances. A managed device is a wireless communication device, which communicates over the field area network 102 using network resources received from one or more distributed coordinators. A distributed coordinator is a wireless communication device, which assigns and distributes network resources for use on the field area network 102. As set forth herein, a distributed coordinator may also prescribe the conditions, under which such network resources may be used.

One of the functions of a distributed coordinator is distributing network control plane information through various network messages, include network information broadcasts (NIBs), multicast messages, and unicast messages. The control plane information includes information about network resources and requirements that a managed device must meet in order to use those resources.

A network resource may be a physical carrier, one or more time slots of a physical carrier, one or more time slots in each of two or more physical carriers, and the like. A network resource may also include a frequency. For example, a network resource may be an allocation to transmit on a particular frequency during particular time slots.

Network information (i.e., sent by the distributed coordinators) may include a network resource and one or more requirements controlling the use of the network resource. Using this network information, as described herein, allows for dynamic radio area network synchronization. Examples of requirements include a usage requirement (e.g., a guard time, a guard band), a frequency accuracy requirement (e.g., a maximum allowable frequency error) and a slot time accuracy requirement (e.g., a client's transmission timing accuracy with respect to a network timing source). In some aspects, a network resource may be associated with multiple requirements of the same or different type (e.g., multiple guard times across one or more time slots).

FIG. 2 schematically illustrates one example embodiment of a wireless communication device of the field area network 102. The example illustrated is the first base station 106. In the embodiment illustrated, the base station 106 includes an electronic processor 205, a memory 210, a communication interface 215, a baseband processor 220, a transceiver 225, and an antenna 230. The illustrated components, along with other various modules and components are coupled to each other by or through one or more control or data buses (for example, the bus 235) that enable communication therebetween. The description of base station 106 is provided as a representative example of other wireless communication devices of the field area network 102, including base stations 108 and 110. In some aspects, one or more of the end nodes and the core network gateway 118, although they may not have identical functions and capabilities, include systems or devices having a similar general component configuration as the base station 106, in that they each include a respective electronic processor, memory, communication interface, input/output interface, and/or radiofrequency communication components coupled by at least one communication bus.

The electronic processor 205 may include one or more microprocessors, an application-specific integrated circuit (ASIC), or another suitable electronic device. The electronic processor 205 obtains and provides information (e.g., to and from the memory 210 and/or the communication interface 215) and processes the information by executing one or more software instructions or modules, capable of being stored, for example, in a random access memory (“RAM”) area of the memory 210, a read only memory (“ROM”) of the memory 210, or another non-transitory computer readable medium (not shown). The software can include firmware, one or more applications, program data, filters, rules, one or more program modules, and other executable instructions. In the embodiment illustrated, the memory 210 stores, among other things, dynamic radio area network synchronization routines 240 (described herein).

The electronic processor 205 is configured to retrieve from the memory 210 and execute, among other things, software related to the control processes and methods described herein. The electronic processor 205 executes instructions stored in the memory 210 to implement functionality of the first base station 106.

The electronic processor 205 is configured to control the baseband processor 220 and the transceiver 225 to transmit and receive radiofrequency signals to and from the second end node 114 (and/or other end nodes) using the antenna 230. As described herein, the base station 106 is configured to operate using TDMA-based data link layer communication. It should be noted that many base stations and other communication devices typically employ multiple antennas in practice, to realize spatial diversity (e.g., MIMO). The electronic processor 205, the baseband processor 220, and the transceiver 225 may include various digital and analog components (for example, digital signal processors, high band filters, low band filters, and the like), which for brevity are not described herein and which may be implemented in hardware, software, or a combination of both. In some embodiments, the transceiver 225 is a combined transmitter-receiver component. In other embodiments the transceiver 225 includes or may be replaced by separate transmitter and receiver components.

The electronic processor 205 is configured to control the communication interface 215 (and, in some embodiments, the antenna 230, another antenna (not shown), or a suitable wired connection) to transmit and receive communication signals to and from the core network gateway 118.

In some examples, the components of the field area network 102 implement and operate using a data link layer communication that is Time Division Multiple Access (TDMA) based with a timing structure overlayed on each physical carrier (i.e., frequency). This timing structure, termed dayframe, divides a single day for a given carrier into a hierarchical breakdown of superframes and further into subslots. All the access methods utilized by the link layer deal with time slotted physical carriers. Each physical carrier has a timing structure called a dayframe overlayed onto it to provide the slotting boundaries. A dayframe for a given carrier starts at midnight UTC plus some carrier specific offset that is managed by the RAN. A dayframe lasts for a full day and provides a convenient mechanism for tracking and articulating both date and time between peer link layers simply by maintaining slot time synchronization.

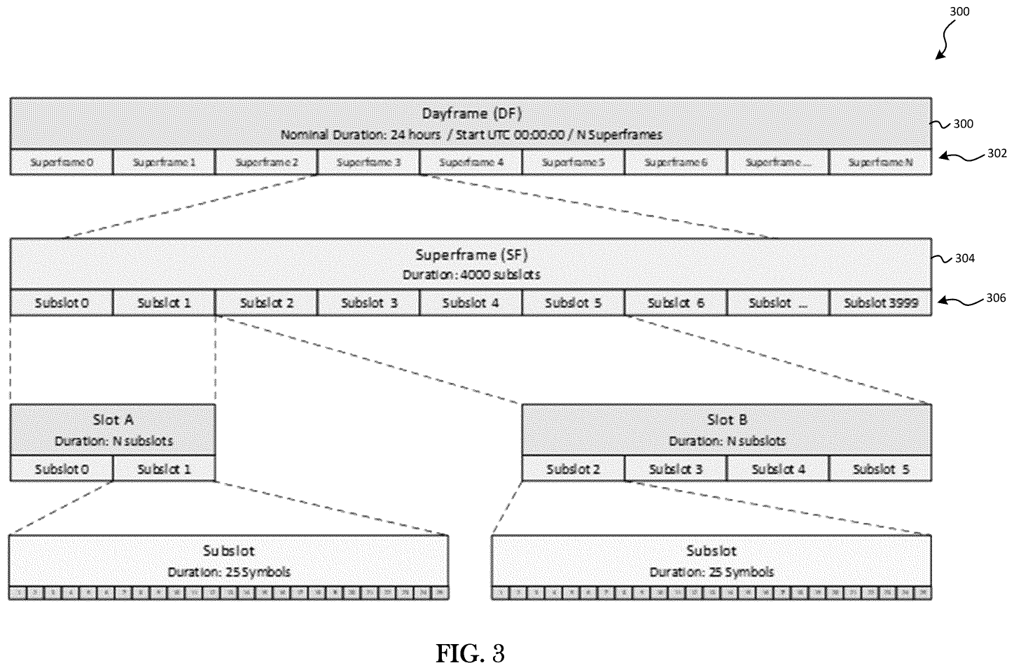

FIG. 3 illustrates one possible example dayframe 300. As illustrated in FIG. 3, the dayframe is comprised of some integer number of superframes 302 (e.g., the superframe 304), which provide the basic periodicity around which network information and link layer services are provided. Each of the superframes 302 is comprised of a set number of subslots 306. The subslot is the atomic unit of time used within the link layer for the TDMA access method. Within a single superframe, the comprising subslots 306 can be partitioned into some number of transmission slots, or just slots (e.g., Slot A and Slot B). These slots are used for a single RF burst from the physical layer and for which the link layer provides timing control. In the illustrated example, each subslot comprises 25 symbols.

FIG. 3 shows an example snapshot of the TDMA framing structure from a temporal perspective. In the illustrated scenario, the link layer has created a Slot A for User A with a duration of two subslots (Subslots 0 and 1) for their needs and has created another Slot B for User B with a duration of four subslots (Subslots 2-5).

The relevant aspect of this dayframe construction is that a given dayframe is tied to an absolute time reference. For example, the reference may be a UTC (Coordinated Universal Time) date and time. In order to communicate on a given carrier, a transmitter (e.g., the first base station 106, the second base station 108, the third base station 110, the first end node 112, the second end node 114, and the third end node 116) must be synchronized to within some fraction of a subslot within the dayframe. Any transmitter that is synchronized sufficiently to transmit on a given physical carrier (i.e., frequency) is already time synchronized to within the same fraction of a subslot to absolute UTC time. Using this foundation, the devices on the field area network 102 are able to operate as described herein. Although the example illustrated and described herein features TDMA, it should be understood that the techniques described herein are applicable to a network operation with any protocol that provides timing in a similar way.

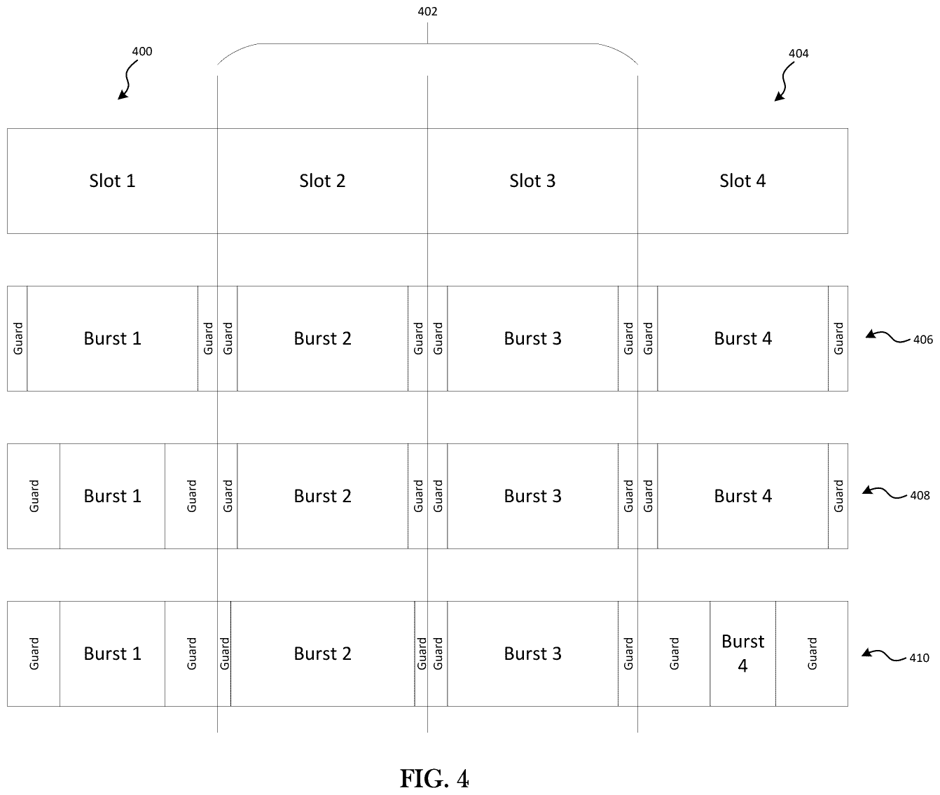

FIG. 4 illustrates some example network resources in terms of time slots. FIG. 4 illustrates three network resources (400, 402, 404). Network resources 400 and 404 each consist of one time slot. Network resource 402 consists of two time slots. Each of the slots 1-4 is comprised of a radio transmission period (e.g., Bursts 1-4) interposed between a leading guard time and trailing guard time. For each slot, both guard times are equivalent in size and are an integer number of symbols. Each of the network resources is illustrated in three configurations (406, 408, 410). As illustrated the guard times may vary. As described herein, radios that are not perfectly synchronized to the RAN will have radio transmission timing errors and therefore require guard times to mitigate self-interference. Guard times may be assigned to a network resource based on network conditions, device capabilities, or both. As illustrated by the three configurations (406, 408, 410) in FIG. 4, the guard times may vary with conditions and capabilities as those change during network operations.

In some embodiments, the radio area network includes disparate network devices (nodes), and utilizes dynamic RAN synchronization to reduce error and improve utilization of network resources. RAN synchronization may include Frequency Synchronization (FS) and Slot Time Synchronization (STS). The frequency synchronization (FS) function distributes a frequency reference throughout the network, which enables network devices to reduce their transmission frequency error. The slot time synchronization (STS) function distributes a slot time reference throughout the network which enables network devices to reduce their slot time transmission error.

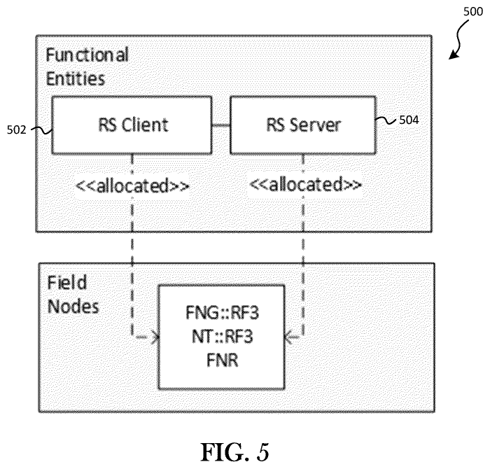

In some embodiments, these functions are realized through a Client/Server architecture where the link layer of each node is assigned the role of Server and/or Client. FIG. 5 illustrates the functional allocations for the RAN synchronization functions. The functional entities 500 comprising the RAN synchronization architecture are the RAN Synchronization Client (RS Client) 502 and the RAN Synchronization Server (RS Server) 504. RS Servers and Clients work together (e.g., by exchanging messages) to synchronize frequency and timing to reduce errors. For example, RS Clients may be able to determine timing and frequency error values through comparison to RS Servers or signals used for calibration. For example, one or more of the network messages may include timing information, which the RS Client can compare to its internal clock. In another example, the RS Client device may send a message to an RS Server requesting a frequency report. The RS Server returns a message indicating the frequency of the received signal from the RS Client, which the RS Client can use to calculate an offset (frequency error). Other methods of synchronization are possible.

Any RAN node may take on the role of function specific RS Clients and/or RS Servers and role assignments may be allocated to field nodes based on many different factors. These factors may include a node's state, the node's role (e.g., as a distributed coordinator or a managed device), the specific system design instantiation, and the specific network deployment design.

In some aspects, the field nodes of the radio area network are able to take advantage of the RAN synchronization process to dynamically allocate network resources. Network resources are allocated by network resource servers to network resource clients, which may use the network resources to transmit data on the network. Network resource servers and clients may also serve as RS Servers and Clients, though those functions are not explicitly linked: an RS Server may be a network resource client and vice versa. In some examples, a distributed coordinator operates as a network resource server to allocate network resources to one or more managed devices (acting as network resource clients). In some examples, a distributed coordinator operates as a network resource server to allocate network resources to managed devices, other distributed coordinators, or both. In some examples, a managed device may allocate network resources to other managed devices, distributed coordinators, or both. The methods 600 and 700, presented herein, describe the operation of the network resource client and network resource server, respectively.

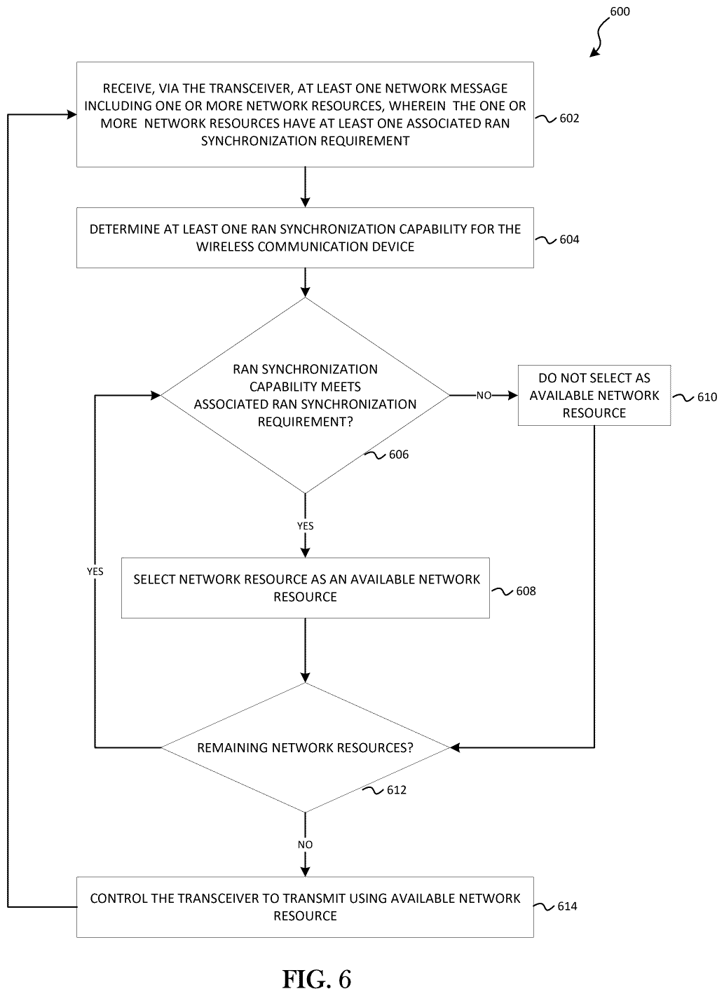

FIG. 6 illustrates an example method 600 for, among other things, operating a network resource client. Although the method 600 is described in conjunction with the system 100 as described herein, the method 600 may be used with other systems and devices. In addition, the method 600 may be modified or performed differently than the specific example provided.

As noted, both end nodes and base stations may be assigned as a server or a client. By way of example, the method 600 is described as being performed by the second base station 106 acting as a network resource client and, in particular, the electronic processor 205. However, it should be understood that portions of the method 600 may be performed by other devices, including for example, one or more of the end nodes working in concert with one or more base stations. Additional electronic processors may also be included in the first base station 106 or other control equipment for the field area network 102 (not shown) that perform all or a portion of the method 600. For ease of description, the method 600 is described partially in terms of a single client and a single server. However, the method 600 may be applied to systems including multiple clients and servers. The method 600 is also applicable to any pair of devices exchanging packets using an absolute time reference, as described herein.

The method 600 begins, at block 602, with the electronic processor 205 receiving (e.g., via the transceiver 225, one or more network messages including one or more network resources, wherein each of the one or more network resources has at least one associated RAN synchronization requirement. For example, one or more of the network messages may be broadcast messages, used to distribute network resources available to any user of the network. In another example, one or more of the network messages may be a multicast messages, used to distribute network resources to a group of users, of which the first base station 106 is a part. In yet another example, one or more of the network messages may be unicast messages, used to assign a resource specifically to the first base station 106.

As noted, network resources may be at least one time slot of a physical carrier, and at least one time slot in each of two or more physical carriers. For example, a network message may include a network resource defined by a frequency and a one or more time slots. Each of the network resources identified in the network messages has at least one associated RAN synchronization requirement. The term “RAN synchronization requirement,” as used herein, refers to a requirement, which must be met by a network resource client in order to transmit using the network resource, to which the requirement applies. The RAN synchronization requirement is so titled because the requirements are typically related to aspects of the radio area network, which are synchronized through some mechanism (e.g., frequency and time, as noted herein). In one non-limiting example, a network message may include a network resource defined by a frequency and a one or more time slots and RAN synchronization requirements of a minimum guard time for the time slots and a maximum frequency error for the frequency.

At block 604, the electronic processor 205 determines at least one RAN synchronization capability for the wireless communication device (e.g., the first base station 106). Field nodes, including those acting as network resource clients, determine their RAN synchronization capabilities (e.g., as described herein with respect to the method 700). Example RAN synchronization capabilities include a time error and a frequency error. For example, the electronic processor 205 may retrieve from the memory 210 values for time and frequency error. In another example, the electronic processor may be able to determine its timing and frequency error values using RAN synchronization techniques as described herein.

In some examples, regardless of how the RAN synchronization capabilities are determined, the electronic processor 205 controls the transceiver to transmit, via a signaling channel, one or more RAN synchronization capabilities to one or more network resource server devices (e.g., via a network message). As described herein, the network resource server devices may use the reports to allocate network resources.

As the electronic processor 205 receives network resource information, it determines one or more available network resources from those received. An available network resource is one that the client may use (e.g., as an uplink to transmit data).

For each of the one or more network resources received, the electronic processor 205 (at block 606) determines whether the applicable RAN synchronization capability meets an associated RAN synchronization requirement for the network resource. For example, where the RAN synchronization requirement is a minimum guard time, the electronic processor 205 determines whether the time error for the client will enable it to transmit using the minimum guard time. In another example, where the RAN synchronization requirement is a maximum frequency error, the electronic processor 205 determines whether the frequency error for the client is below the maximum allowable frequency error.

When the electronic processor 205 determines (at block 606) that the applicable RAN synchronization capability meets the associated RAN synchronization requirement for a network resource (or that all applicable requirements for a network resource are met), it selects that network resource as being an available network resource. At block 610, where one or more requirements are not met by the network resource client's RAN synchronization capabilities, the electronic processor 205 does not select the associated network resource as an available network resource. As illustrated in FIG. 6, the electronic processor 205 continuously evaluates the received network resources until/unless none remain for evaluation (at block 612). At block 614, the electronic processor 205 controls the transceiver 225 to transmit using at least one available network resource. Which of the available network resources are used may depend on other unrelated factors (e.g., quality of service, the type of data being transmitted, and the like).

In some aspects, the network resource client is capable of dynamically adjusting to changing conditions. For example, the electronic processor 205 may periodically evaluate and update its RAN synchronization capabilities (e.g., time and/or frequency error). When a RAN synchronization capability is updated, the electronic processor 205, in response to the update, re-evaluates and updates the available network resources based on the updated RAN synchronization capability, as described above (at blocks 606-612).

In some examples, in addition to or rather than receiving network resources and associated requirements from a network resource server, a network resource client may have one or more network resource allocations coded in its memory. In such examples, the network resource client is also configured to access those resources dynamically as described above with respect to resources received from network resource clients.

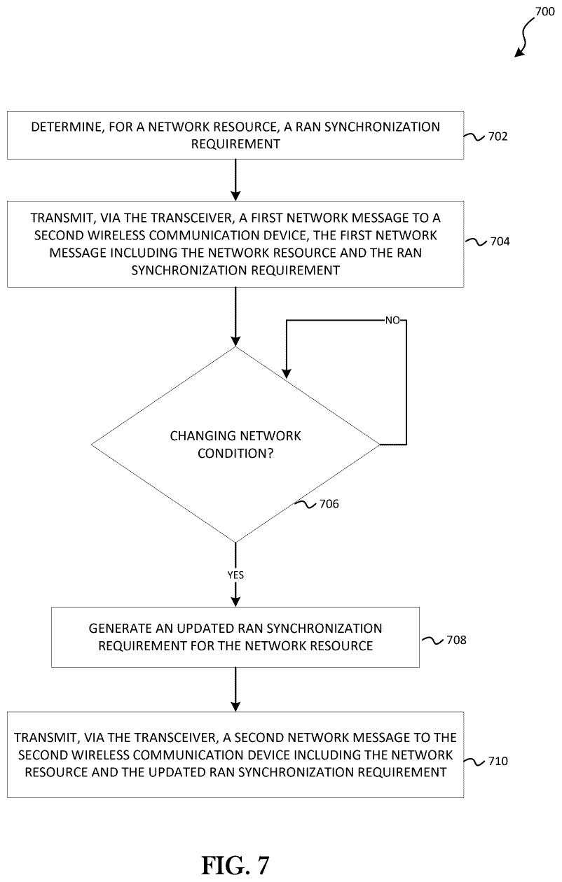

As described herein with respect to FIG. 7, the network resource servers may update and/or reassign network resources. Accordingly, the client may receive a second network message including one of the one or more network resources and at least one updated associated RAN synchronization requirement for that network resource. In such instances, the electronic processor 205 updates the available network resources based on the one or more updated associated RAN synchronization requirements (e.g., by determining whether its capabilities meet the updated requirements).

FIG. 7 illustrates an example method 700 for, among other things, operating a network resource server to dynamically allocate network resources to network resource clients. Although the method 700 is described in conjunction with the system 100 as described herein, the method 700 may be used with other systems and devices. In addition, the method 700 may be modified or performed differently than the specific example provided.

As noted, both end nodes and base stations may be assigned as a server or a client. By way of example, the method 700 is described as being performed by the second base station 106 acting as a server and, in particular, the electronic processor 205. However, it should be understood that portions of the method 700 may be performed by other devices, including for example, one or more of the end nodes working in concert with one or more base stations. Additional electronic processors may also be included in the first base station 106 or other control equipment for the field area network 102 (not shown) that perform all or a portion of the method 700. For ease of description, the method 700 is described partially in terms of a single server interacting with a single client. However, the method 700 may be applied to systems including multiple base stations and end nodes.

The method 700 begins, at block 702, with the electronic processor 205 determining, for a network resource, a RAN synchronization requirement. In some instances, the electronic processor 205 may determine the RAN synchronization requirement based on an attribute of the wireless communication device, an attribute of the second wireless communication device, or an attribute of the radio area network. Examples of attributes of the wireless communication device include a server side policy and an amount and/or type of available network resources assigned to the server. Examples of attributes of the radio area network include current wireless conditions, a network state (e.g., current load on one or more network resources or the network as a whole). Examples of attributes of the second wireless communication device (i.e., to which the network resource will be assigned) include its capabilities, its traffic requirements, and the type of the client device. For example, a resource assigned to ad hoc devices, for which little is known before they join the network, may be giving a larger guard time or a higher maximum frequency error. Similarly, the electronic processor 205 may determine the RAN synchronization requirement based on a network role for the client device. In another example, the electronic processor 205 may determine the RAN synchronization requirement based on an initial RAN synchronization capability for the client device (e.g., a default value assigned at startup or when the device is first encountered). For example, the electronic processor 205 may retrieve the initial RAN synchronization capability (e.g., in the form of a hardware specification) from the memory 210 or may receive it in a network message from the client device (e.g., as part of a network registration process). Therefore, the electronic processor 205 may select the network resource based on the initial RAN synchronization capability and the RAN synchronization requirement for the network resource (e.g., assigning network resources to client devices based on their respective abilities to use the resources).

In some instances, the network resource server repeats this process for many client devices, selecting requirements for network resources to be assigned network-wide, to groups of client devices, and to individual client devices.

At block 704, the electronic processor 205 transmits, via the transceiver, a first network message to a second wireless communication device (e.g., a network resource client device). The first network message includes the network resource and the RAN synchronization requirement. As described herein, the first network message may be a broadcast message (e.g., assigning the network resource to all client devices on the network), a multicast message (e.g., assigning the network resource to a group of client devices), or a unicast message (e.g., assigning the network resource to a single client device). By way of example, the method 700 is described in terms of transmitting a single network message including a single network resource/RAN synchronization requirement pair. However, other configurations are possible. For example, a single network resource may have more than one requirement associated with it. In another example, multiple network resources may share one or more requirements. One to many, many to one, and many to many arrangements are all possible.

At block 706, the electronic processor 205 determines whether there is a changing network condition. A changing network condition may include a change in an attribute of the wireless communication device (i.e., the network resource server, a change in an attribute of the second wireless communication device (i.e., the network resource client), or a change in an attribute of the radio area network itself (e.g., the links between the server devices and the client devices). For example, the electronic processor 205 may detect a change in timing (e.g., loss of a timing signal, switching to a less reliable time source, and the like) for the network resource server device. In other examples, the electronic processor 205 may detect a change (e.g., an increase or decrease) in the RSSI or SINR of received signals from the network resource client device by the network resource server device, a change in frequency allocation (e.g., adding or removing available frequencies from use), or a change in the quantity of client wireless devices (e.g., the network becomes more or less crowded).

At block 708, the electronic processor 205, responsive to determining a changing network condition, generates an updated RAN synchronization requirement for the network resource. For example, where the changing network condition is a loss of timing for the server device, it may produce the updated RAN synchronization requirement by increasing guard times for the network resource. In another example, adjacent frequencies may be assigned for use near an existing network resource, requiring decreasing the maximum frequency error allowable for transmitting on that network resource so as to reduce the likelihood of interference with the adjacent frequencies.

At block 710, the electronic processor 205 transmits, via the transceiver 225, a second network message to the second wireless communication device including the network resource and the updated RAN synchronization requirement. As with the first network message, the second network message may be sent as a broadcast, multicast, or unicast message (e.g., typically matching the type of the first network message). In some examples, to reduce signaling overhead, the second network message may include a reference to the network resource, rather than including the entire network resource definition.

Returning to block 706, in some instances, the electronic processor 205 may detect the changing network condition based on signaling from the second wireless communication device (i.e., the client device). For example, there may be a lack of signaling from the second wireless communication device over some or all of its assigned network resources. Signaling may be entirely lacking or may fall below a pre-set threshold, either case indicating that it is possible that there has been a change in the RAN synchronization capabilities of the client device. For example, it may have experienced a loss of timing and may no longer be able to use previously assigned network resources with relatively low guard times.

In another example, the electronic processor 205 may detect the changing network condition based on a characteristic of a signal received from the client device. For example, the server device may monitor the RSSI for signals received from the client device and re-evaluate the assignment of network resources based on that metric.

The electronic processor 205 may determine an updated RAN synchronization capability for the second wireless communication device based on the evaluation of the signaling. In another example, the electronic processor 205 may receive a network message from the second wireless communication device including the updated RAN synchronization capability for the second wireless communication device and consider this a change in network conditions.

The electronic processor 205 may generate the updated RAN synchronization requirement based on the updated RAN synchronization capability (e.g., increasing or lowering guard times or maximum frequency errors as appropriate to the change detected).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

In the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make any one or more than one of the multiple determinations.

Moreover, an embodiment can be implemented as a computer-readable storage medium having computer readable code stored thereon for programming a computer (for example, comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The following paragraphs provide various examples of the embodiments disclosed herein.

Clause 1. A wireless communication device comprising: an electronic processor; and a transceiver coupled to the electronic processor; wherein the electronic processor is configured to: receive, via the transceiver, at least one network message including one or more network resources, wherein the one or more network resources have at least one associated RAN synchronization requirement; determine at least one RAN synchronization capability for the wireless communication device; determine at least one available network resource by selecting, from the one or more network resources the at least one available network resource when the at least one RAN synchronization capability meets the at least one associated RAN synchronization requirement; and control the transceiver to transmit using the at least one available network resource.

Clause 2. The wireless communication device of clause 1, wherein the electronic processor is further configured to: determine at least one updated RAN synchronization capability for the wireless communication device; and update the at least one available network resource based on the at least one updated RAN synchronization capability.

Clause 3. The wireless communication device of clause 1, wherein the electronic processor is further configured to: receive a second network message including one of the one or more network resources and at least one updated associated RAN synchronization requirement for that one of the one or more network resources; and update the at least one available network resource based on the at least one updated associated RAN synchronization requirement.

Clause 4. The wireless communication device of clause 1, wherein the electronic processor is further configured to: control the transceiver to transmit, via a signaling channel, the at least one RAN synchronization capability.

Clause 5. The wireless communication device of clause 1, wherein the electronic processor is further configured to: determine the at least one RAN synchronization capability by determining at least one selected from a group consisting of a time error and a frequency error.

Clause 6. The wireless communication device of clause 1, wherein the electronic processor is further configured to: receive at least one network message by receiving at least one selected from a group consisting of a broadcast message, a multicast message, and a unicast message.

Clause 7. The wireless communication device of clause 1, wherein each of the plurality of network resources is at least one selected from a group consisting of at least one time slot of a physical carrier, and at least one time slot in each of two or more physical carriers.

Clause 8. A wireless communication device operating on a radio area network, the device comprising: an electronic processor; and a transceiver coupled to the electronic processor; wherein the electronic processor is configured to: determine, for a network resource, a RAN synchronization requirement; transmit, via the transceiver, a first network message to a second wireless communication device, the first network message including the network resource and the RAN synchronization requirement; responsive to determining a changing network condition, generate an updated RAN synchronization requirement for the network resource; and transmit, via the transceiver, a second network message to the second wireless communication device including the network resource and the updated RAN synchronization requirement.

Clause 9. The wireless communication device of clause 8, wherein the electronic processor is further configured to: determine, for the second wireless communication device, an initial RAN synchronization capability; and select the network resource based on the initial RAN synchronization capability and the RAN synchronization requirement.

Clause 10. The wireless communication device of clause 9, wherein determining the initial RAN synchronization capability is based on at least one selected from a group consisting of a hardware capability of the second wireless communication device and receiving the initial RAN synchronization capability from the second wireless communication device.

Clause 11. The wireless communication device of clause 8, wherein determining the RAN synchronization requirement is based on at least one selected from a group consisting of an attribute of the wireless communication device, an attribute of the second wireless communication device, and an attribute of the radio area network.

Clause 12. The wireless communication device of clause 8, wherein the electronic processor is further configured to: determine the changing network condition based on signaling from the second wireless communication device; determine an updated RAN synchronization capability for the second wireless communication device based on the signaling; and generate the updated RAN synchronization requirement based on the updated RAN synchronization capability.

Clause 13. The wireless communication device of clause 12, wherein the signaling is at least one selected from a group consisting of a lack of signaling from the second wireless communication device, a characteristic of a signal received from the second wireless communication device, and a network message from the second wireless communication device including the updated RAN synchronization capability for the second wireless communication device.

Clause 14. The wireless communication device of clause 8, wherein the electronic processor is further configured to determine the changing network condition based on at least one selected from a group consisting of a change in an attribute of the wireless communication device, a change in an attribute of the second wireless communication device, and a change in an attribute of the radio area network.

Clause 15. The wireless communication device of clause 8, wherein the electronic processor is further configured to transmit the first network message by transmitting at least one selected from a group consisting of a broadcast message, a multicast message, and a unicast message.

Clause 16. The wireless communication device of clause 8, wherein the electronic processor is further configured to transmit the second network message by transmitting at least one selected from a group consisting of a broadcast message, a multicast message, and a unicast message.

Clause 17. The wireless communication device of clause 8, wherein the network resource is at least one selected from a group consisting of at least one time slot of a physical carrier and at least one time slot in each of two or more physical carriers.

Clause 18. The wireless communication device of clause 8, wherein the electronic processor is further configured to: determine the RAN synchronization requirement by determining at least one selected from a group consisting of a usage requirement, a frequency accuracy requirement, and a slot time accuracy requirement.

We claim:

1. A wireless communication device comprising:
an electronic processor; and
a transceiver coupled to the electronic processor;
wherein the electronic processor is configured to:
receive, via the transceiver, at least one network message including one or more network resources, wherein the one or more network resources have at least one associated RAN synchronization requirement;
determine at least one RAN synchronization capability for the wireless communication device;
determine at least one available network resource by selecting, from the one or more network resources the at least one available network resource when the at least one RAN synchronization capability meets the at least one associated RAN synchronization requirement; and
control the transceiver to transmit using the at least one available network resource.

2. The wireless communication device of claim 1, wherein the electronic processor is further configured to:
determine at least one updated RAN synchronization capability for the wireless communication device; and
update the at least one available network resource based on the at least one updated RAN synchronization capability.

3. The wireless communication device of claim 1, wherein the electronic processor is further configured to:
receive a second network message including one of the one or more network resources and at least one updated associated RAN synchronization requirement for that one of the one or more network resources; and
update the at least one available network resource based on the at least one updated associated RAN synchronization requirement.

4. The wireless communication device of claim 1, wherein the electronic processor is further configured to:
control the transceiver to transmit, via a signaling channel, the at least one RAN synchronization capability.

5. The wireless communication device of claim 1, wherein the electronic processor is further configured to:
determine the at least one RAN synchronization capability by determining at least one selected from a group consisting of a time error and a frequency error.

6. The wireless communication device of claim 1, wherein the electronic processor is further configured to:
receive at least one network message by receiving at least one selected from a group consisting of a broadcast message, a multicast message, and a unicast message.

7. The wireless communication device of claim 1, wherein each of the plurality of network resources is at least one selected from a group consisting of at least one time slot of a physical carrier, and at least one time slot in each of two or more physical carriers.

8. A wireless communication device operating on a radio area network, the device comprising:
an electronic processor; and
a transceiver coupled to the electronic processor;
wherein the electronic processor is configured to:
determine, for a network resource, a RAN synchronization requirement;
transmit, via the transceiver, a first network message to a second wireless communication device, the first network message including the network resource and the RAN synchronization requirement;
responsive to determining a changing network condition, generate an updated RAN synchronization requirement for the network resource; and
transmit, via the transceiver, a second network message to the second wireless communication device including the network resource and the updated RAN synchronization requirement.

9. The wireless communication device of claim 8, wherein the electronic processor is further configured to:
determine, for the second wireless communication device, an initial RAN synchronization capability; and
select the network resource based on the initial RAN synchronization capability and the RAN synchronization requirement.

10. The wireless communication device of claim 9, wherein determining the initial RAN synchronization capability is based on at least one selected from a group consisting of a hardware capability of the second wireless communication device and receiving the initial RAN synchronization capability from the second wireless communication device.

11. The wireless communication device of claim 8, wherein determining the RAN synchronization requirement is based on at least one selected from a group consisting of an attribute of the wireless communication device, an attribute of the second wireless communication device, and an attribute of the radio area network.

12. The wireless communication device of claim 8, wherein the electronic processor is further configured to:
determine the changing network condition based on signaling from the second wireless communication device;
determine an updated RAN synchronization capability for the second wireless communication device based on the signaling; and
generate the updated RAN synchronization requirement based on the updated RAN synchronization capability.

13. The wireless communication device of claim 12, wherein the signaling is at least one selected from a group consisting of a lack of signaling from the second wireless communication device, a characteristic of a signal received from the second wireless communication device, and a network message from the second wireless communication device including the updated RAN synchronization capability for the second wireless communication device.

14. The wireless communication device of claim 8, wherein the electronic processor is further configured to determine the changing network condition based on at least one selected from a group consisting of a change in an attribute of the wireless communication device, a change in an attribute of the second wireless communication device, and a change in an attribute of the radio area network.

15. The wireless communication device of claim 8, wherein the electronic processor is further configured to transmit the first network message by transmitting at least one selected from a group consisting of a broadcast message, a multicast message, and a unicast message.

16. The wireless communication device of claim 8, wherein the electronic processor is further configured to transmit the second network message by transmitting at least one selected from a group consisting of a broadcast message, a multicast message, and a unicast message.

17. The wireless communication device of claim 8, wherein the network resource is at least one selected from a group consisting of at least one time slot of a physical carrier and at least one time slot in each of two or more physical carriers.

18. The wireless communication device of claim 8, wherein the electronic processor is further configured to:
determine the RAN synchronization requirement by determining at least one selected from a group consisting of a usage requirement, a frequency accuracy requirement, and a slot time accuracy requirement.
